(19) United States
(12) Patent Application Publication
(10) Pub. No.: US 2010/0193293 A1
(43) Pub. Date: Aug. 5, 2010

(54) Under-ground raise, manhole, vault, or man-way safe entry/exit system

(76) Inventors: Terence Michael Murray, Kitchener (CA); Robert W. Duench, St Jacobs (CA); Brad R. Bender, Wellesley (CA); Tim O. Collins, Kitchener (CA)

Correspondence Address: Terence Michael Murray, 32 Glen Lake Crescent, Kitchener, Ontario, N2N-1C5, CA

(21) Appl. No.: 12/461,439

(22) Filed: Aug. 12, 2009

(30) Foreign Application Priority Data
Aug. 19, 2008 (CA) 2,638,357

(51) Int. Cl. E06C 9/02; E05C 1/04

(52) U.S. Cl. 182/93; 292/137

(57) ABSTRACT

A safety system, attached to the underside of an access (lid, cover, grill, grate, or hatch) that allows the user to mount and dismount an access ladder below in an ergonomic and safe manner. The system comprises of a locking device and two handrails attached to the underside of the access cover. The handrails are attached in line with the access ladder handrails. When the access cover is in a vertical open position the locking device slides down into a hollow receiver sleeve that is in a fixed position below the surface of the access cover. This secures the access cover in a vertical open position, allowing the user to utilize the handrails on the underside of the access cover as an extension of the ladder handrails that are affixed below the surface of the access cover.

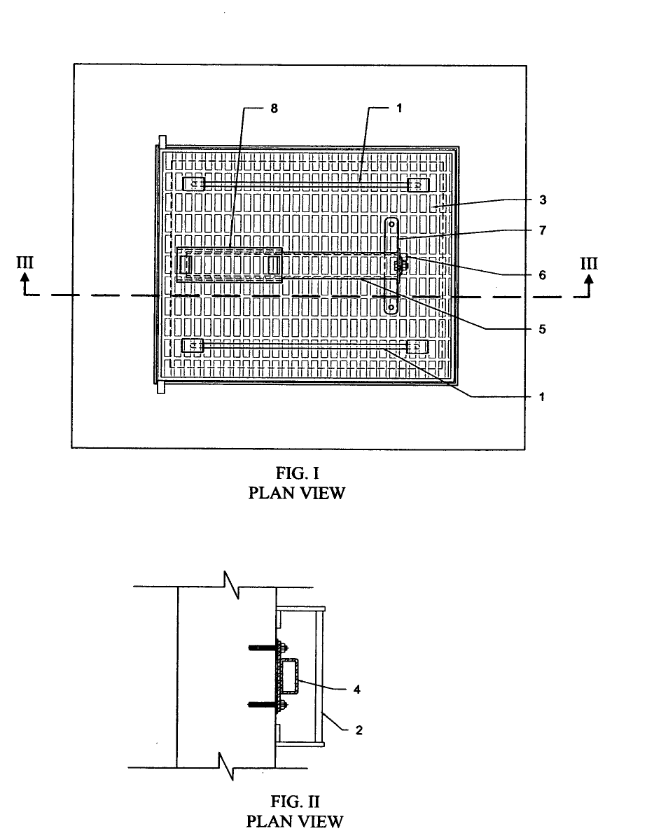

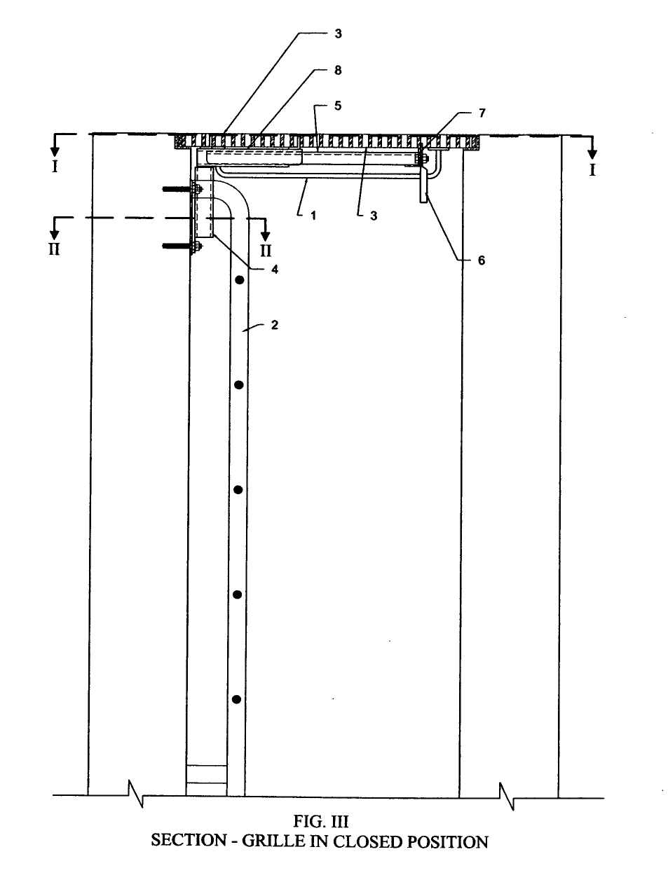

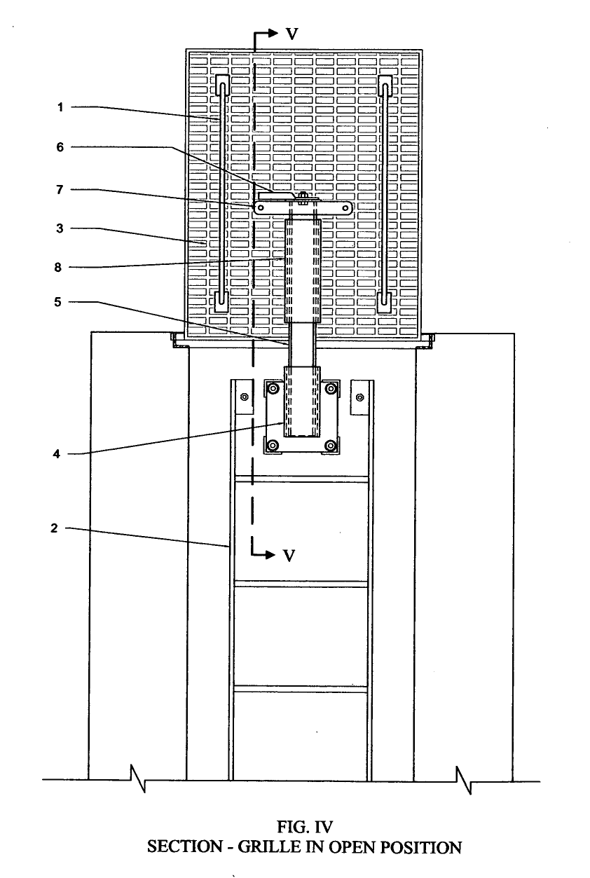

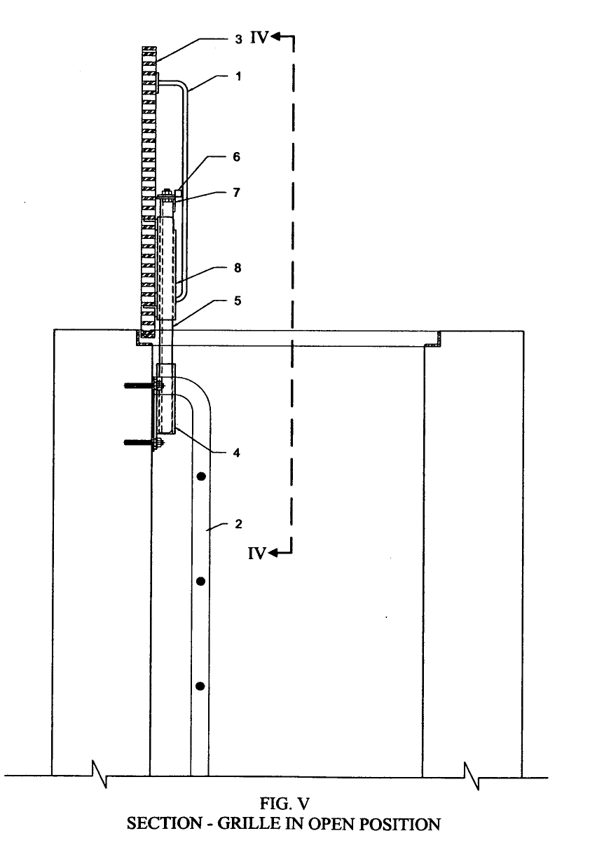

### CROSS-REFERENCE TO RELATED APPLICATIONS

The present application claims priority of Canadian patent application number 2,638,357 filed on Aug. 19, 2008, which is hereby incorporated by reference.

### STATEMENT REGARDING FEDERALLY SPONSORED RESEARCH OR DEVELOPMENT

“Not Applicable”

### THE NAMES OF THE PARTIES TO A JOINT RESEARCH AGREEMENT

“Not Applicable”

### INCORPORATION-BY-REFERENCE OF MATERIAL SUBMITTED ON A COMPACT DISC

“Not Applicable”

### BACKGROUND OF THE INVENTION

(1) Field of the Invention

The present invention relates to the extensions of ladder-way systems, for underground raises, manholes, vaults, man-ways, (or any ladder below surface of a walk area).

(2) Description of the Related Art Including Information Disclosed Under 37 CFR 1.97 and 37 CFR 1.98

Most manhole ladders and ladder-way systems are mounted on the inside wall below the surface of the manhole, vault, man-ways or raise, so that the entrance can be covered with a man-way or access (lid, cover, grate, grill or hatch). The fact that the top of the ladder is below the surface entrance makes it difficult and unsafe to mount and dismount the top of the ladder, typically the man-way or access (lid, cover, grate, grill or hatch) has to be removed, the user then has to support themselves on the rim of the cover while crouching to reach the top rung of the ladder. Such an entry is dangerous as the user could slip or fall while doing this manoeuvre causing an injury to the user. The danger is worsened when the user is carrying tools and safety equipment or rescue equipment e.g. (oxygen bottle, harness, or gas monitor) in a confined space,

Some prior art devices tried to address this problem, but still left the user with some problems, in particular U.S. Pat. Nos. 3,598,200 (Thompson) and 4,546,855 (Lyons) both disclose a single rod device from inside a manhole where it is slidably retracted to the middle of the upper rungs of a manhole ladder. Thompson has added a support at the lower end of the rod to releasably engage a ladder rung to retain the rod in an extended position. The support may be accidentally dislodged during use by a relatively small upward movement of the rod, causing the rod to collapse.

The Lyons rod has an involved arrangement of brackets, plates, and pins that must be hand-activated by a lever mechanism to retain the rod in the extended position. The arrangement is cumbersome since it requires a two-handed operation to raise or lower the rod. The number of parts in the Lyons system makes it needlessly complex and expensive to produce. In any event, the rods of both patents obstruct the middle of each manhole ladder and consume what little space one had on the rungs of the ladder for foot and hand placement. The location of the rods also requires the user to swing about the post in order to mount and dismount the ladder, which is a potentially dangerous manoeuvre over an open manhole. There is also the inconvenience of not being able to carry tools or the like since both hands must grab the post during such maneuvering.

Also CA patent 2228729 (Lorentz) whose device does overcome the limitations and disadvantages of the prior art devices, but as well still does have limitations and disadvantages, it is extendable from inside the manhole which means user has to bend right over and reach into the manhole to gain access to the device, and then pull the device up into position. This device is attached to the handrails of the fixed wall mounted ladder-way, which makes for an obstruction of your grasp of the handrails as you reach the top of the manhole, but this device is ideal for a round manhole man-way or access (lid, cover, grate, grill or hatch).

What is therefore desired is a novel device to facilitate safe entry and exit of a manhole above the manhole ladder, which overcomes the limitations and disadvantages of the prior art devices. Preferably the device should provide secure hand placements that extend above the manhole, and does not obstruct the manhole ladder space. The device should be simple in design and be inexpensive to build and install.

The present invention is a novel device, which overcomes all these limitations and disadvantages but has limitations to man-way or access (lids, covers, grates, grills or hatches) that are hinged. Preferably the device should have two handrails that do not interfere with foot space on any ladder rungs or obstruct the handrails of the fixed wall mounted ladder. The handrails should be capable of quick and easy positioning with a simple means of positively locking the man-way or access (lid, cover, grate, grill or hatch) in a vertical open position.

### BRIEF SUMMARY OF THE INVENTION

The present invention has provided a safety system for a manhole ladder, or ladder-way, having two elongated handrails attached to the underside of manhole man-way or access (lid, cover, grate, grill or hatch) fixed in a permanent position, so as when the man-way or access (lid, cover, grate, grill or hatch) is in a vertical open position the handles act as an extension of the ladder handrails below.

This invention has provided a locking device (post member), that is mounted inside a hollow sleeve, which is permanently attached to the underside of the man way or access (lid, cover, grate, grill or hatch), so that when the man-way or access (lid, cover, grate, grill or hatch) is raised to a vertical position the user is able to unlatch the locking device (post member) from its stored position and slide it down by means of gravity, into a hollow receiver sleeve mounted on the wall of the manhole. By doing this it locks the man-way or access (lid, cover, grate, grill or hatch) in a vertical position allowing the user to grasp the handrails attached to the man way or access (lid, cover, grate, grill or hatch) upon mounting or dismounting the ladder below, without any obstruction or limitations of the opening to the ladder below. This device also prevents accidental closing of the man-way or access (lid, cover, grate, grill or hatch). This device is also fitted with a handle on the top of the locking device (post member) to allow the user to lift the locking device (post member) back into the stored position, when it is not being used. The invention has a weighted latch, which is attached to the top of the handle that enables the user to store the locking device (post member) in the stored position, so that it stays in place without causing any obstruction when the user is opening and closing the man-way or access (lid, cover, grate, grill or hatch).

### BRIEF DESCRIPTION OF THE SEVERAL VIEWS OF THE DRAWINGS

Embodiments of the invention will now be described by way of example only, with preference to the accompanying diagrams wherein.

FIG. I Is a top view of a man-way or access “lid, cover, grate, grill or hatch” (3). With a transparent view of a locking device “post member” (5) in the stored position with the “elongated handrails” (1) attached to the underside of the man-way or access “lid, cover, grate, grill or hatch” (3).

FIG. II Is a top view showing the relationship of the “hollow receiver sleeve” (4) location to both the manhole “ladder” (2) and mounting surface of a man-way.

FIG. III Is a side view of FIG. I and FIG. II with man-way or access “lid, cover, grate, grill or hatch” (3) in the closed position, showing the locking device “post member” (5) being held in the stored position, by the “weighted latch” (6). It also shows a side view of the “elongated handrails” (1) on the underside of the man-way or access “lid, cover, grate, grill or hatch” (3).

FIG. IV Is a front view of FIG. I and FIG. II with the man-way or access “lid, cover, grate, grill or hatch” (3) in a vertical open position, being held in place by a locking device “post member” (5) being dropped down into the “hollow receiver sleeve” (4), which is mounted on the wall or the back of the “ladder” (2).

FIG. V Is a side view of FIG. I and FIG. II with the man-way or access “lid, cover, grate, grill or hatch” (3) in a vertical open position, being held in place by a locking device “post member” (5) being dropped down into the “hollow receiver sleeve” (4), which is mounted on the wall or the back of the “ladder” (2).

### DETAILED DESCRIPTION OF THE INVENTION

FIG. I Is a top view of a man-way or access “lid, cover, grate, grill or hatch” (3) with a transparent view of two “elongated handrails” (1) attached to the underside of the man-way or access “lid, cover, grate, grill or hatch” (3), by the way of welding or equivalent means. It also shows a locking device “post member” (5), this is housed in a “hollow sleeve” (8) which is attached by welding or equivalent means to the underside of the man-way or access “lid, cover, grate, grill or hatch” (3). The locking device “post member” (5) is secured in a stored non-operational position by a “weighted latch” (6) which stays in place by force of gravity, while man-way or access “lid, cover, grate, grill or hatch” (3) is being opened or closed.

FIG. II Shows the “hollow receiver sleeve” (4) for locking device “post member” (5) attached to the wall of the manhole, vault, ladder-way, or backside of the “ladder” (2) in alignment with the edge of the manhole just under the rim of the man-way or access “lid, cover, grate, grill or hatch” (3).

FIG. III Shows a side view of FIG. I and FIG. II, it shows a man-way or access “lid, cover, grate, grill or hatch” (3) in a closed position, it shows the locking device “post member” (5) in a non-operational stored position seated in the “hollow sleeve” (8) which is attached to the underside of the man-way or access “lid, cover, grate, grill or hatch” (3) by welding or equivalent means. It shows “weighted latch” (6) in locked position preventing locking device “post member” (5) from sliding as the man-way or access “lid, cover, grate, grill or hatch” (3) is being opened. It shows a side view of ladder-way below the man-way or access “lid, cover, grate, grill or hatch” (3) with the position of the “ladder” (2) and the position of the “hollow receiver sleeve” (4) attached to the wall or the backside of the “ladder” (2).

FIG. IV Shows a front view of FIG. I and FIG. II with the man-way or access “lid, cover, grill, grate, or hatch” (3) in a vertical open position locked in place, by means of the locking device “post member” (5) which has been unlatched from the stored position and slid down through the “hollow sleeve” (8) into the “hollow receiver sleeve” (4). The locking device “post member” (5) slides down by the force of gravity until the “handle” (7) seats in the recess at the top of the “hollow sleeve” (8) locking the man-way or access “lid, cover, grate, grill or hatch” (3) in the vertical open position. The “elongated handrails” (1) on the underside of the man-way or access “lid, cover, grate, grill or hatch” (3) now to act as extension of the “ladder” (2) handrails, to allow safe mounting and dismounting of the manhole “ladder” (2) below. It also prevents the man-way or access “lid, cover, grate, grill or hatch” (3) from being closed accidentally and protects one side of the manhole. The locking device “post member” (5) also has a “handle” (7) on the top for the user to grasp when lifting the locking device “post member” (5) into the stored position to allow the man-way or access “lid, cover, grate, grill or hatch” (3) to be closed.

FIG. V Shows a side view of FIG. I and FIG. II with the man-way or access “lid, cover, grill, grate, or hatch” (3) in a vertical open position locked in place, by means of the locking device “post member” (5) which has been unlatched from the stored position and slid down through the “hollow sleeve” (8) into the “hollow receiver sleeve” (4). The locking device “post member” (5) slides down by the force of gravity until the “handle” (7) seats in the recess at the top of the “hollow sleeve” (8) locking the man-way or access “lid, cover, grate, grill or hatch” (3) in the vertical open position. The “elongated handrails” (1) on the underside of the man-way or access “lid, cover, grate, grill or hatch” (3) now to act as extension of the “ladder” (2) handrails, to allow safe mounting and dismounting of the manhole “ladder” (2) below. It also prevents the man-way or access “lid, cover, grate, grill or hatch” (3) from being closed accidentally and protects one side of the manhole. The locking device “post member” (5) also has a “handle” (7) on the top for the user to grasp when lifting the locking device “post member” (5) into the stored position to allow the man-way or access “lid, cover, grate, grill or hatch” (3) to be closed.

The operation of the present invention may be better appreciated in FIG. V it shows how the present invention when operated in the open position is unrestricted for easy mounting and dismounting of the man-way ladder (2) below. It shows the position of the elongated handrails (1) for easy grasp when the user is stepping onto or off the top rung of the ladder (2). It shows how the man-way or access “lid, cover, grate, grill or hatch” (3) in the open position protects one side of the access hole. It shows how once the man-way or access “lid, cover, grate, grill or hatch” (3) is lifted the user does not need to bend far to grasp the “handle” (7) to unlock the “weighted latch” (6) before letting the locking device “post member” (5) drop into the “hollow receiver sleeve” (4) by the force of gravity, this helps prevent back injuries. Some of the many other advantages of the present invention may also be appreciated as follows: The user does not have to bend and reach into the manhole to access the device, when the man-way or access “lid, cover, grate, grill or hatch” (3) is raised it is above the knee level and below the waist level in height. The user has unobstructed access to the top of the ladder (2) rungs, while using the elongated handrails (1) on the man-way or access “lid, cover, grate, grill or hatch” (3) for support and balance during mounting and dismounting from the “ladder” (2), thus eliminating the user from having to remove the man-way or access “lid, cover, grate, grill or hatch” (3) totally from the manhole to gain access to the “ladder” (2) below. This benefits the user by having to do less lifting, twisting, and bending.

The whole description for this present invention is illustrative rather than a restrictive sense, and variations to the specific configurations described maybe apparent to a skilled person in adapting the present invention to other specific applications. Such variations are intended to form part of the present invention in so far as they are within the spirit and scope of the claims below.

Example: The hollow sleeve (8) need not be one continuous piece, but can be two rings that the locking device “post member” (5) slides through.

Example: The “hollow sleeve” (8) and the “hollow receiver sleeve” (4) need not be rectangular in shape; it can be round or square.

Example: The locking device “post member” (5) does not have to be shaped as a rectangle, it can be shaped round or square, but it will have to match the shape of the hollow sleeve 8) and the “hollow receiver sleeve” (4).

Example: Locking device “post member” (5) can be solid, hollow, or open C channel shaped material.

Example: This safety system is not only for a manhole, under-ground vault, under-ground raise, or man-way, but can be used for any access “lid, cover, grate, grill or hatch” (3) that is hinged and provides access to a ladder below the surface of the access “lid, cover, grate, grill or hatch” (3).

Example: The two elongated handrails (1) attached to the bottom of the man-way or access “lid, cover, grate, grill or hatch” (3) need not be two solid elongated handrails (1), they can be in two parts, so that when the man-way or access “lid, cover, grate, grill or hatch” (3) is in the open position the elongated handrails (1) can be extended higher or lower to meet the various safety codes, by the means of telescopic handles or fold down handle extensions.

Example: The safety system could be manufactured from any variety of materials e.g. (metal, alloys, fibreglass, plastic, or composites, stainless steel, steel, iron, or aluminum).

1) On the underside of any manhole, under-ground vault, under-ground raise or man-way, access lid, cover, grill, grate or hatch consisting of any shape capable of allowing a person or persons to enter or exit a man-way ladder, consisting of a plurality of elongate rungs supported between the upright side rails being secured to a plurality of wall brackets fixed to an inside surface of a manhole. The improvement comprising of a hollow sleeve permanently attached to the underside of the access lid, cover, grill, grate or hatch by weld or equivalent means, which houses an inner sliding locking device (post member) moveable between an inoperative/closed position when not in use, to an operative/open position when man-way entry or exit is required. It also includes a permanently mounted hollow receiver sleeve mounted beneath the access lid, cover, grill, grate or hatch, on the inside of the man-way. The improvement also includes two handrails which are fastened by weld or equivalent means to the underside of the access lid, cover, grill, grate, or hatch, which are parallel with the man-way ladder handrails when the access lid, cover, grill, grate, or hatch is in the operative/open position.

2) The access lid of claim#1. Wherein said has two elongated handrails attached to the underside of the said lid, by weld or other equivalent means, that are used as an extension of the handrails of the ladder below the lid.

3) The access lid of claim#2. Wherein said has a hollow sleeve attached to the underside of the lid by weld or other equivalent means.

4) The hollow sleeve of claim#3. Wherein said houses a sliding locking device (post member) that is used to lock the lid in a vertical open position, when the user needs to mount or dismount the ladder below the man-way lid, cover, grill, grate or hatch.

5) The sliding locking device (post member) of claim#4. Wherein said is attached a handle to the top of it, by weld or other equivalent means, for the user to grasp when the user is lowering the said post member from an un-operational position to an operational position, and to grasp when the user is raising the locking device (post member) from an operational position to an un-operational position.

6) The handle of claim#5. Wherein said has attached to the top side of it a weighted latch that turns freely, so that when the lid is in the closed position the latch stays in place by the force of gravity, herein locking the said locking device (post member) in a stored un-operational position until user opens the lid and releases the latch manually.

7) The man-way of claim#1. Wherein the said has a hollow receiver sleeve attached to the wall by the means of wall anchors, or to the backside of the ladder in such a position that when the said lid is in the open position the said locking device (post member) is able to slide downwards into the hollow receiver sleeve, until the said handle of claim #5, rests on the top of the said hollow sleeve of claim #2, and to support the said locking device (post member) Thereon, and to prevent further sliding there through.

8) The hollow sleeve of claim#2. Wherein the said hollow sleeve can be made of Steel, stainless steel, iron, aluminum, metal, Fiberglas, plastic, or alloy.

9) The handrails of claim#3. Wherein the handrails can be made of steel, stainless steel, iron, aluminum, metal, fibreglass, plastic, or alloy.

10) The locking device (post member) of claim#4. Wherein the locking device (post member) can be made of steel, stainless steel, iron, aluminums, metal, fibreglass, plastic, or alloy.

11) The handle of claim#5. Wherein the handle can be made of steel, stainless steel, iron, aluminums, metal, fibreglass, plastic, or alloy.

12) The weighted latch of claim#6. Wherein the weighted latch can be made of steel, stainless steel, iron, aluminums, metal, Fiberglas, plastic, or alloy.

13) The hollow sleeve of claim#7. Wherein the hollow sleeve can be made of steel, stainless steel, iron, aluminums, metal, fibreglass, plastic, or alloy.
